(19) United States
(12) Patent Application Publication
(10) Pub. No.: US 2014/0253105 A1
(43) Pub. Date: Sep. 11, 2014

(54) METHOD FOR DETERMINING A ROTARY SPEED OF A DEVICE

(71) Applicants: Jacek Wiszniewski, Leinfelden-Echterdingen (DE); Kamil Pogorzelski, Stuttgart (DE); Michael Maercker, Stuttgart (DE)

(72) Inventors: Jacek Wiszniewski, Leinfelden-Echterdingen (DE); Kamil Pogorzelski, Stuttgart (DE); Michael Maercker, Stuttgart (DE)

(73) Assignee: Robert Bosch GmbH, Stuttgart (DE)

(21) Appl. No.: 14/128,729

(22) PCT Filed: Apr. 26, 2012
(86) PCT No.: PCT/EP2012/057681

§ 371 Date: Apr. 18, 2014

(30) Foreign Application Priority Data
Jun. 24, 2011 (DE) 10 2011 078 041.6

(51) Int. Cl. G01P 3/481

(52) U.S. Cl. CPC G01P 3/481
USPC 324/173

(57) ABSTRACT

A device configured for rotary speed measurement includes a speed transmitter on which segments are distributed across a radial circumference and a sensor that is substantially stationary relative to the speed transmitter. A method for determining the rotary speed of the device includes continuously determining pass-through times of all segments relative to the sensor, continuously determining revolution times of the speed transmitter by summing the pass-through times of all segments over a complete revolution, and continuously determining the speed from the revolution times. The revolution times are determined after each pass-through of a segment relative to the sensor and the most current pass-through times of all segments are used for determining each revolution time. Since the time for a full revolution is calculated for each segment respectively, differences in the length of individual segments due to production do not have any negative influence on the calculation of speed.

The invention relates to a method for determining a rotational speed of a device.

### PRIOR ART

The usual way to detect a rotational speed is to measure in periodic intervals a rotation period from which a rotational speed is determined in periodic intervals. Also known for the purpose of determining the rotational speed is to carry out a count of pulses which are generated by means of a speed sensor (such as, for example, a magnet wheel) which is divided into segments (for example poles of the magnet wheel). In this case, pulses are counted per defined times and the rotational speed is determined therefrom taking account of a number of pole pairs of the electric motor. Also, it is further known to determine times between the pulses from which rotational speeds are calculated.

Said customary methods have the disadvantage of all having a relatively coarse resolution. This is particularly owing to the fact that measurements of revolution periods of complete revolutions of a shaft of the electric motor are carried out in order to detect the rotational speed. In the case of slowly rotating devices or of devices which are subject to rapid rotational speed fluctuations a time between two measurements can be greater than a time base of one revolution of the motor, which, for example, is a function of a supply frequency of an electrical supply voltage. Consequently, it is, for example, possible for a detection of the rapid drop in rotational speed and an appropriate control to be delayed in a disadvantageous way. Furthermore, because of an asymmetric division of a single segment (for example poles in the case of a magnet wheel), the rotational speed cannot be determined accurately from the time measurement of a single speed sensor segment (for example in the case of a magnet wheel).

In the case that a device is rotating very slowly, it can be that the rotation time is longer than a time base which corresponds to a fixed time interval between the expected pulses. The disadvantage is that an accurate rotational speed cannot be determined by means of the known methods described.

It is therefore the object of the present invention to provide an improved method for determining a rotational speed.

The object is achieved by means of a method for determining a rotational speed of a device, the device having a speed sensor on which segments distributed over a radial circumference are arranged, the device having a sensor which is substantially stationary relative to the speed sensor, exhibiting:
continuous determination of passage times of all the segments relative to the sensor,
continuous determination of rotation times of the speed sensor by summing the passage times of all the segments, and
continuous determination of the rotational speed from the rotation times; the rotation times being determined after each passage of a segment relative to the sensor, the most current passage times of all the segments being used to determine each rotation time.

The method according to the invention can advantageously be used to measure rotational speeds of the device more accurately and more frequently than by using customary methods, as a current value of the total rotation period is determined by making use of the passage times of all the segments that have respectively been determined last. The reason for this is that the total rotation time is determined after each passage of a segment in front of the sensor, which also means that the rotational speeds are determined much more frequently and more currently. It is thereby advantageously possible to respond more rapidly to abrupt changes in the rotational speed of the device.

In accordance with a preferred development of the method according to the invention, it is provided that the segments have different arc lengths. An accurate detection of the current revolution period and/or the rotational speed of the device is also supported thereby in the case of asymmetric design of the segments that is formed in this way. The method is therefore advantageously independent of a particular configuration of the segment lengths.

An advantageous development of the method provides that the speed sensor is designed as a magnet wheel, a number of the segments being correlated with a number of poles of the magnet wheel, a number of the segments being at most equal to the number of the poles. There is advantageously support thereby for a simple configuration and adaptation of the method and a high accuracy of the detection of rotational speed.

An advantageous development of the method provides that the segments of the speed sensor are implemented by software. In this way, the method according to the invention can be carried out in a simple way without any sort of hardware adaptation of the device.

The invention is explained in detail below with the aid of three figures. The figures are primarily intended to explain the principles essential to the invention. Particular dimensions, design features or any sorts of parameter cannot be gathered from the figures.

In the figures:

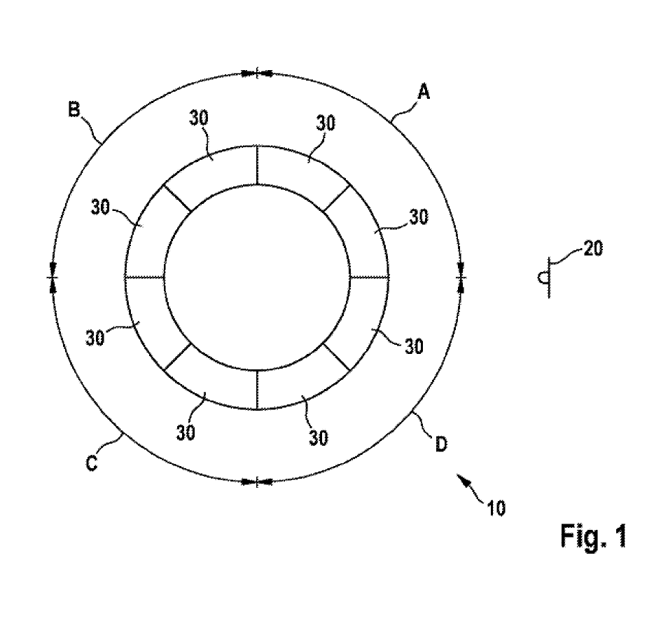

FIG. 1 shows a schematic of a speed sensor, subdivided into segments, of a device for carrying out the method according to the invention;

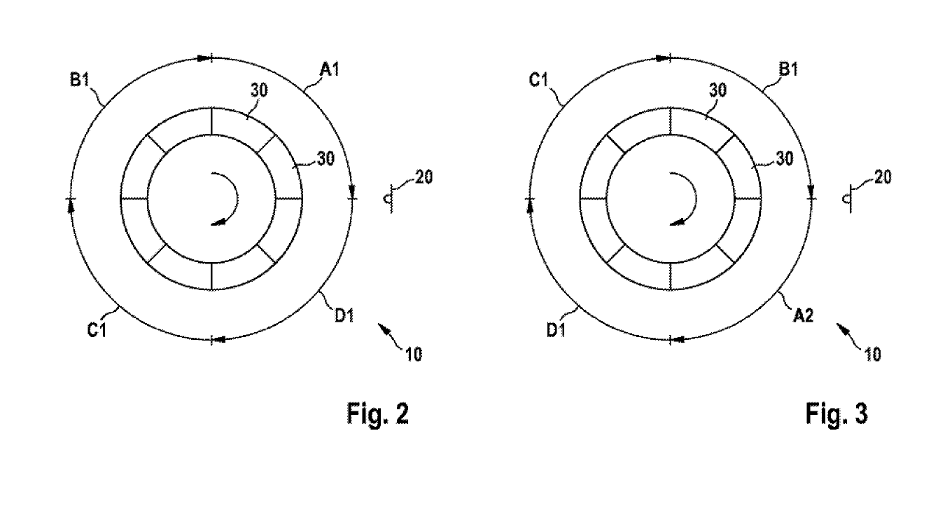

FIG. 2 shows a schematic of the speed sensor after a complete rotation; and

FIG. 3 shows a schematic of the speed sensor after a further segmental rotation.

A speed sensor designed as a magnet wheel 10 of an electric motor (not illustrated) is shown schematically in FIG. 1, the magnet wheel 10 having eight poles 30 uniformly distributed on its radial circumference. Each of the poles 30 corresponds in this case with regard to design to a magnetic pole having a north or south magnetic pole. The magnet wheel 10 can, for example, be designed as a magnet wheel for a fan for an electric motor of a power tool. For technical reasons in the determination of rotational speed, the circumference of the magnet wheel 10 with the poles 30 is subdivided into four individual, arcuate segments A, B, C, D, in each case two poles 30 being assigned to one of the segments A, B, C, D. A number of the poles 30 correlates with a number of the segments A, B, C, D, and must be at least two, a number of the segments A, B, C, D being able at most to be equal to a number of the poles 30. In the exemplary embodiment of FIGS. 1 to 3, a number of the segments A, B, C, D is half as large as a number of the poles 30 (four segments, eight poles).

In the figure, the segments A, B, C, D each have an equal arc length, but it is also possible for the segments A, B, C, D respectively to have different arc lengths and be distributed in such a way over the radial circumference of the magnet wheel 10. A sensor is essentially arranged so as to be stationary relative to the magnet wheel 10 inside the electric motor. The sensor 20 serves to detect passage times of the segments A, B, C, D in front of the sensor 20. For this purpose, the sensor 20 is capable of detecting a start and an end of each segment A, B, C, D (for example, by means of known optical or inductive sensor principles) and, as a result, of determining the time which each segment A, B, C, D requires to move completely past the sensor 20. These times are designated as passage times of the segments A, B, C, D in the context of the method according to the invention.

FIG. 2 is a schematic of the magnet wheel 10 after a first complete rotation relative to the sensor 20, the segments A, B, C, D being provided with indices to better understand the method according to the invention. In this case, Al corresponds to a first completed rotation or passing movement of the segment A in front of the sensor 20. B1 corresponds to a first completed rotation or passing movement of the segment B in front of the sensor 20. C1 corresponds to a first completed rotation or passing movement of the segment C in front of the sensor 20. D1 corresponds to a first completed rotation or passing movement of the segment D in front of the sensor 20. A direction of rotation of the magnet wheel 10 of the electric motor is indicated by an arrow for the direction of rotation, the method according to the invention being independent of the direction of rotation.

According to the invention, in order to detect a total rotation time or period of the magnet wheel 10, a summation of determined passage times of respectively all the segments A, B, C, D is now carried out in the following way in periodic intervals:

t=A1+B1+C1+D1 (first rotation of the magnet wheel 10 completed)

t . . . instant of the determination of the rotation time.

FIG. 3 shows in principle that a determination of the next rotation period is carried out at an instant t1 (subsequent to the instant t) when the magnet wheel 10 has rotated further by one segment. In the exemplary embodiment of FIG. 3, the further rotation by one segment corresponds to a quarter rotation of the magnet wheel 10. In this case, the index of the segment A is increased by one to two. The aim is thus to indicate by the designation A2 that the passage time of the segment A in front of the sensor 20 and by means of the sensor 20 has already been detected for a second time. To this end, the segment A has thus already moved past in front of the sensor 20 for a second time.

The most current passage time A2 of the segment A and the already detected passage times of the segments B, C and D are thus now employed to determine the rotation time of the magnet wheel 10. This may be represented mathematically in the following way:

t1=B1+C1+D1+A2

t1 . . . instant of the determination of the rotation time.

A determination of a further rotation time is carried out at an instant t2 (subsequent to t1) when the magnet wheel 10 has, in turn, rotated further by one segment (not illustrated). In order to determine the total rotation time of the magnet wheel 10, use is now made of the most current passage time B2 of the segment B and the already detected passage times of the segments C, D and A. The rotation time determined at the instant t2 may thus be represented mathematically in the following way:

t2=C1+D1+A2+B2

t2 . . . instant of the determination of the rotation time.

A further determination of the rotation time of the magnet wheel 10 is carried out at an instant t3 (subsequent to t2) when the magnet wheel 10 has, in turn, rotated further by one segment (not illustrated) such that in order to calculate the rotation period the most current passage time C2 of the segment C is now employed together with the already detected passage times of the segments D, A and B. This may be represented mathematically in the following way:

t3=D1+A2+B2+C2

t3 . . . instant of the determination of the rotation time.

A further determination of the rotation time is carried out at an instant t4 (subsequent to t3) when the magnet wheel 10 has, in turn, rotated further by one segment such that in order to determine the rotation period of the magnet wheel 10 the most current passage time D2 of the segment D is now employed together with the already detected passage times of the segments A, B and C. This may be represented mathematically in the following way:

t4=A2+B2+C2+D2 (second rotation of the magnet wheel 10 completed)

t4 . . . instant of the determination of the rotation time.

By means of the exemplary embodiment, shown with the aid of FIGS. 1 to 3, of the method according to the invention, a detection of rotation times and measurement of rotational speeds has been performed four times between two rotations of the magnet wheel 10, and thus substantially more frequently than in the case of the customary methods.

Thus, it can be seen from the above explanations that the determination of the rotation time of the magnet wheel 10 is carried out periodically in time intervals which correspond respectively to a passage of a segment A, B, C, D in front of the sensor 20. In this case, a respectively currently determined passage time of one of the segments A, B, C, D is used as partial rotation time in order to detect the total rotation period of all the segments A, B, C, D and/or of the magnet wheel 10.

Depending on the number of segments, it is possible in this way to determine a rotation period and/or a rotational speed from the rotation period in a way advantageously substantially more frequent than by means of the known customary methods. Consequently, it is also possible for control of the electric motor to react substantially more rapidly to abrupt changes in rotational speed. It is advantageously possible, for example, to very rapidly enable a safety functionality of a so-called kick-back detection which detects a rapid drop in rotational speed and carries out a shutdown of the electric motor and/or suitable steps to control the electric motor.

By means of the method according to the invention, one asymmetric design of the pole pairs 30—and thus of the segments A, B, C, D—advantageously has no disadvantageous effects on accuracy of the measurements of rotational speeds carried out.

The implementation of the segments A, B, C, D in the electric motor can preferably be performed by means of software for control electronics, with the advantageous result that there is no need for any sort of hardware changes to the electric motor. A simple, cost-effective and rapid change of lengths of the individual segments A, B, C, D is supported in this way. The invention can be used for every type of electric motor having a magnet wheel (armature/rotor), for example for a universal motor or for a brushless DC motor. In particular, the invention is also very useful for any desired electric motor which is used in a power tool whose measurement of rotational speed is carried out by means of internal electronics.

In summary, it is proposed to determine a rotational speed of a device by measuring rotation periods on the basis of segments, rotation times being determined periodically in time intervals corresponding to segment passages. A higher scanning rate is attained owing to the detection of rotation times on the basis of segments, and so it is advantageously possible to carry out a calculation of rotational speed substantially more frequently. By comparison with customary methods, it is advantageously possible to detect substantially lower rotational speeds using the same time base. A delayed control owing to excessively slow, outdated rotational speed information is substantially excluded in this way. Features of the electric motor which are related to safety and require real time information on rotational speed, such as, for example, a kick-back detection in the case of a power tool, are promoted in accordance with the invention.

It is obvious to the person skilled in the art that the described features of the invention can be modified and combined in a fashion known to those skilled in the art.

1. A method for determining a rotational speed of a device, the device having a speed sensor on which segments are distributed over a radial circumference and a sensor which is substantially stationary relative to the speed sensor, the method comprising:
continuously determining passage times of all the segments relative to the sensor:
continuously determining rotation times of the speed sensor by summing the passage times of all the segments; and
continuously determining the rotational speed from the rotation times, the rotation times being determined after each passage of a segment relative to the sensor, the most current passage times of all the segments being used to determine each rotation time.

2. The method as claimed in claim 1, wherein the segments have different arc lengths.

3. The method as claimed in claim 1, wherein the speed sensor is configured as a magnet wheel, wherein a number of the segments being are correlated with a number of poles of the magnet wheel, and wherein the number of the segments are at most equal to the number of the poles.

4. The method as claimed in claim 1, wherein the segments of the speed sensor are implemented by software.

5. A device for executing a method for determining a rotational speed of a device, the device including a speed sensor on which segments are distributed over a radial circumference and a sensor which is substantially stationary relative to the speed sensor, the method comprising:
continuously determining passage times of all the segments relative to the sensor;
continuously determining rotation times of the speed sensor by summing the passage times of all the segments; and
continuously determining the rotational speed from the rotation times, the rotation times being determined after each passage of a segment relative to the sensor, the most current passage times of all the segments being used to determine each rotation time.

6. The device as claimed in claim 5, wherein the device is configured to be used in an electric motor.
